(19) United States
(12) Patent Application Publication
(10) Pub. No.: US 2026/0291154 A1
(43) Pub. Date: Sep. 24, 2026

(54) Electrical Connector Structure

(71) Applicant: Dongguan YUQIU Electronic Co., Ltd., Dongguan (CN)

(72) Inventors: JI GAO QIAN, Dongguan (CN); XIN QIAN, Dongguan (CN); Ke HUI Li, Dongguan (CN)

(21) Appl. No.: 19/238,637

(22) Filed: Jun. 16, 2025

(30) Foreign Application Priority Data
Mar. 19, 2025 (TW) 114110376

(51) Int. Cl. H01R 24/64; H01R 13/717; H01R 107/00

(52) U.S. Cl. CPC H01R 24/64; H01R 13/7172; H01R 2107/00

(57) ABSTRACT

The invention discloses an electrical connector structure, which includes a signal terminal set and a grounding terminal set. The signal terminal set includes the first to eighth signal terminals, each of which has a signal solder pin at one end, that is, the signal terminal set has the first to eighth signal solder pins; the grounding terminal set includes at least five grounding solder pins, and the five grounding solder pins and the first to eighth signal solder pins are arranged in an identical direction, whereby the first to eighth signal solder pins and the five ground solder pins are arranged in a sequence of one grounding solder pin, the first and second signal solder pins, one grounding solder pin, the fourth and fifth signal solder pins, one grounding solder pin, third and the third and sixth signal solder pins, one grounding solder pin, the seventh and eighth signal solder pins and the last ground solder pin; by this arrangement design method, the first to eighth signal solder pins and the five ground solder pins can be arranged side by side are disposed in an alternate manner.

### BACKGROUND OF THE INVENTION

### Field of the Invention

The invention relates to a technical field of electrical connector, and more particularly to an electrical connector configured to mate with a plug of RJ45 connected to a cable.

### Description of the Related Art

Conventional RJ (Registered Jack) electrical connectors mainly include two kinds, the RJ11 connectors and the RJ45 connectors. The RJ45 connectors have a size greater than that of the RJ11 connectors, and each of the RJ45 connectors has eight terminals for requirements in computer network and digital communication.

As the technology of communication develops, demands for the data transmission speed and the bandwidth for communication are continuously increased, for example the data transmission speed is increased from 155 Mbps to 1 Gbps, 2.5 Gbps or even 10 Gbps, However, the higher data transmission speed the conventional RJ45 connectors provide, more electromagnetic waves are generated by the eight contact terminals, whereby the signals transmitted in the eight terminals are interfered by the electromagnetic waves.

Moreover, the conventional RJ45 connectors have eight terminals arranged in a separated manner, i.e. not in the same axis, which causes a more complicated soldering process for the connectors.

Therefore, it is an important issue for the conventional RJ45 connectors to reduce electromagnetic interference and simplify the soldering process.

### BRIEF SUMMARY OF THE INVENTION

The invention provides an electrical connector structure. The electrical connector structure in accordance with an exemplary embodiment of the invention is configured to mate with a plug of RJ45 connected to a cable. The electrical connector structure of the embodiment includes a signal terminal set and a grounding terminal set. The signal terminal set is disposed in the electrical connector structure and includes a first signal terminal provided with a first signal solder pin, a second signal terminal provided with a second signal solder pin, a third signal terminal provided with a third signal solder pin, a fourth signal terminal provided with a fourth signal solder pin, a fifth signal terminal provided with a fifth signal solder pin, a sixth signal terminal provided with a sixth signal solder pin, a seventh signal terminal provided with a seventh signal solder pin, and an eighth signal terminal provided with an eighth signal solder pin.

The grounding terminal set is disposed in the electrical connector structure and includes at least five grounding solder pins.

The first signal solder pin, the second signal solder pin, the third signal solder pin, the fourth signal solder pin, the fifth signal solder pin, the sixth signal solder pin, the seventh signal solder pin, the eighth signal solder pin, and the grounding solder pins are arranged along an identical direction in a sequence of one of the grounding solder pins, the first signal solder pin, the second signal solder pin, one of the grounding solder pins, the fourth signal solder pin, the fifth signal solder pin, one of the grounding solder pins, the third signal solder pin, the sixth signal solder pin, one of the grounding solder pins, the seventh signal solder pin, the eighth signal solder pin, and one of the grounding solder pins.

The invention features in that two grounding solder pins are disposed at the right side and the left side of the arrangement of the signal solder pins, and three other grounding solder pins are alternately disposed between every two signal solder pins for shielding against electromagnetic interference. Therefore, the signal solder pins and the grounding solder pins are alternately arranged for reduction of electromagnetic interference occurring in the signal terminals.

In addition, as the signal solder pins and the grounding solder pins are arranged in the same axis, the soldering process for the terminals is simplified, and the time required in the soldering process is thus reduced.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is an exploded view of an embodiment of an electrical connector structure of the invention;

FIG. 2 is a perspective view of a signal terminal set and a grounding terminal set of the electrical connector structure of the invention;

FIG. 3 is a perspective view of a signal terminal set and a grounding terminal set of the electrical connector structure of the invention at another view angle;

FIG. 4 is a perspective view of an assembly of the signal terminal set, the grounding terminal set, the insulation base, the light guiding member and the light emitting members of FIG. 1;

FIG. 5 is a partially exploded view of FIG. 4;

FIG. 6 is a perspective view of an assembly of the assembly of FIG. 4 and an insulation housing; and

FIG. 7 is a perspective view of an assembly of the assembly of FIG. 6 and a metal case.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

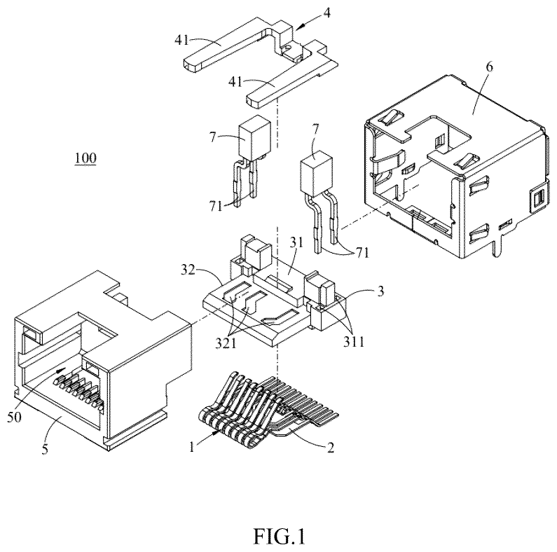

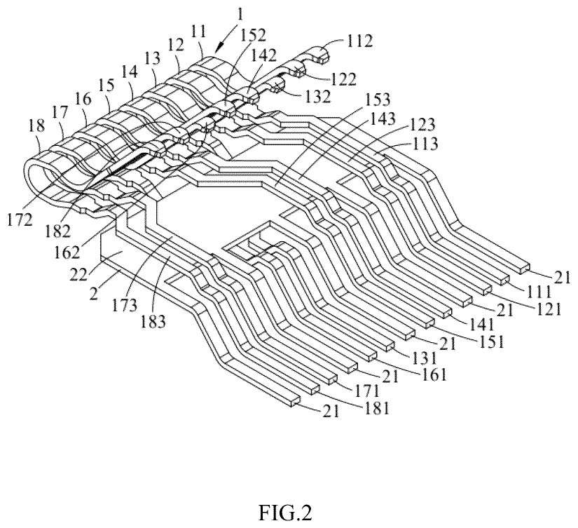

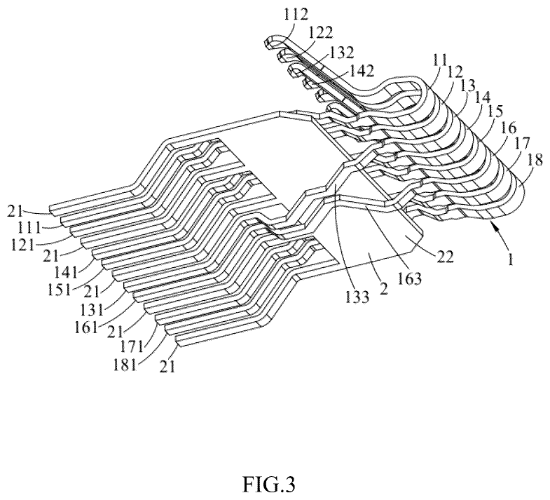

Referring to FIGS. 1, 2 and 3, the invention discloses an embodiment of an electrical connector structure, and particular an electrical connector structure configured to mate with a RJ45 plug connected to a cable. The electrical connector structure 100 includes a signal terminal set 1 and a grounding terminal set 2.

The signal terminal set 1 is disposed in an interior of the electrical connector structure 100, and the signal terminal set 1 includes a first signal terminal 11, a second signal terminal 12, a third signal terminal 13, a fourth signal terminal 14, a fifth signal terminal 15, a sixth signal terminal 16, a seventh signal terminal 17 and an eighth signal terminal 18. The first signal terminal 11 is provided with a first signal solder pin 111, a first contact portion 112 opposite to the first signal solder pin 111 and a first signal section 113 between the first contact portion 112 and the first signal solder pin 111. The second signal terminal 12 is provided with a second signal solder pin 121, a second contact portion 122 opposite to the second signal solder pin 121 and a second signal section 123 between the second contact portion 122 and the second signal solder pin 121. The third signal terminal 13 is provided with a third signal solder pin 131, a third contact portion 132 opposite to the third signal solder pin 131 and a third signal section 133 between the third contact portion 132 and the third signal solder pin 131. The fourth signal terminal 14 is provided with a fourth signal solder pin 141, a fourth contact portion 142 opposite to the fourth signal solder pin 141 and a fourth signal section 143 between the fourth contact portion 142 and the fourth signal solder pin 141. The fifth signal terminal 15 is provided with a fifth signal solder pin 151, a fifth contact portion 152 opposite to the fifth signal solder pin 151 and a fifth signal section 153 between the fifth contact portion 152 and the fifth signal solder pin 151. The sixth signal terminal 16 is provided with a sixth signal solder pin 161, a sixth contact portion 162 opposite to the sixth signal solder pin 161 and a sixth signal section 163 between the sixth contact portion 162 and the sixth signal solder pin 161. The seventh signal terminal 17 is provided with a seventh signal solder pin 171, a seventh contact portion 172 opposite to the seventh signal solder pin 171 and a seventh signal section 173 between the seventh contact portion 172 and the seventh signal solder pin 171. The eighth signal terminal 18 is provided with an eighth signal solder pin 181, an eighth contact portion 182 opposite to the eighth signal solder pin 181 and an eighth signal section 183 between the eighth contact portion 182 and the eighth signal solder pin 181.

The grounding terminal set 2 is disposed in the interior of the electrical connector structure 100. The grounding terminal set 2 includes five grounding solder pins 21 and a grounding substrate 22. The five grounding solder pins 21 are connected to the grounding substrate 22. The first signal solder pin 111, the second signal solder pin 121, the third signal solder pin 131, the fourth signal solder pin 141, the fifth signal solder pin, 151 the sixth signal solder pin 161, the seventh signal solder pin 171, the eighth signal solder pin 181, and the five grounding solder pins 21 are arranged in a row along an identical direction. The arrangement is as the following sequence: one of the grounding solder pins 21, the first signal solder pin 111, the second signal solder pin 121, one of the grounding solder pins 21, the fourth signal solder pin 141, the fifth signal solder pin 151, one of the grounding solder pins 21, the third signal solder pin 131, the sixth signal solder pin 161, one of the grounding solder pins 21, the seventh signal solder pin 171, the eighth signal solder pin 181, and one of the grounding solder pins 21.

Therefore, two grounding solder pins 21 are disposed on a left side of the first signal solder pin 111 and on a right side of the eighth signal solder pin 181 to provide shielding against electromagnetic interference. The other three grounding solder pins 21 are disposed between every two signal solder pins to provide shielding against electromagnetic interference. In this way, the first signal solder pin 111, the second signal solder pin 121, the third signal solder pin 131, the fourth signal solder pin 141, the fifth signal solder pin 151, the sixth signal solder pin 161, the seventh signal solder pin 171, the eighth signal solder pin 181, and the five grounding solder pins 21 are alternately arranged to reduce or even cease the electromagnetic interference between the first signal terminal 11, the second signal terminal 12, the third signal terminal 13, the fourth signal terminal 14, the fifth signal terminal 15, the sixth signal terminal 16, the seventh signal terminal 17 and the eighth signal terminal 18.

The grounding substrate 22 of the grounding terminal set 2 corresponds to a middle portion of the first signal terminal 11, the second signal terminal 12, the third signal terminal 13, the fourth signal terminal 14, the fifth signal terminal 15, the sixth signal terminal 16, the seventh signal terminal 17, and the eighth signal terminal 18 respectively. That is the grounding substrate 22 is located in a position corresponding to the first signal section 113, the second signal section 123, the third signal section 133, the fourth signal section 143, the fifth signal section 153, the sixth signal section 163, the seventh signal section 173, and the eighth signal section 183, whereby the first signal section 113, the second signal section 123, the fourth signal section 143, the fifth signal section 153, the seventh signal section 173, and the eighth signal section 183 are positioned above the grounding substrate 22, and the third signal section 133 and the sixth signal section 163 are positioned under the grounding substrate 22.

The first contact portion 112, the second contact portion 122, the third contact portion 132, the fourth contact portion 142, the fifth contact portion 152, the sixth contact portion 162, the seventh contact portion 172 and the eighth contact portion 182 are arranged in a row along an identical direction. The arrangement is as the following sequence: the first contact portion 112, the second contact portion 122, the third contact portion 132, the fourth contact portion 142, the fifth contact portion 152, the sixth contact portion 162, the seventh contact portion 172 and the eighth contact portion 182.

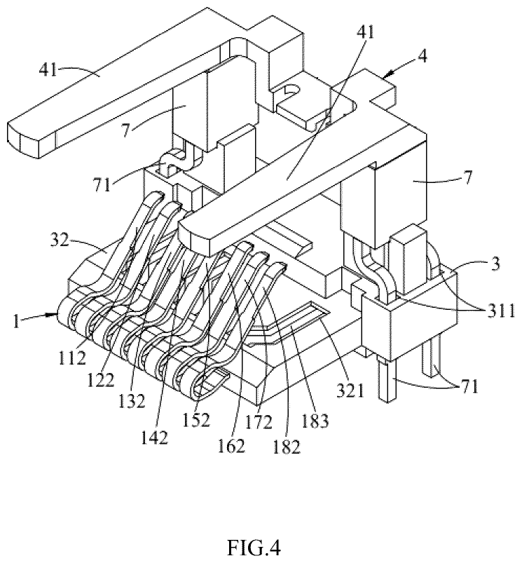

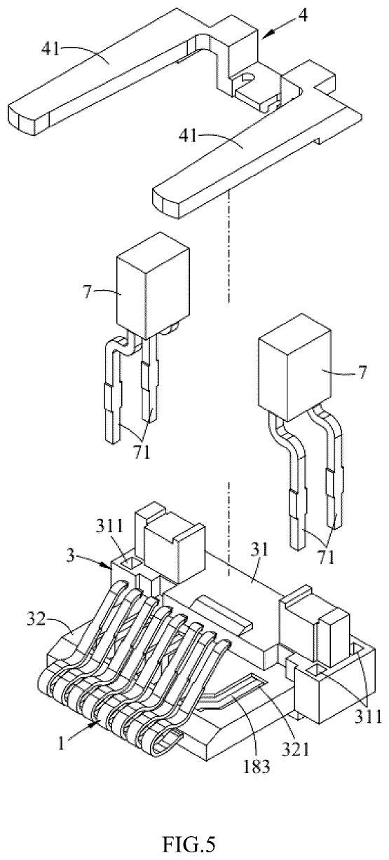

Referring to FIGS. 4 and 5, the electrical connector structure 100 further includes an insulation base 3, at least one light guiding member 4 and at least two light emitting members 7. The insulation base 3 encloses the signal terminal set 1 and the grounding terminal set 2. The first signal solder pin 111, the second signal solder pin 121, the third signal solder pin 131, the fourth signal solder pin 141, the fifth signal solder pin 151, the sixth signal solder pin 161, the seventh signal solder pin 171, the eighth signal solder pin 181, the first contact portion 112, the second contact portion 122, the third contact portion 132, the fourth contact portion 142, the fifth contact portion 152, the sixth contact portion 162, the seventh contact portion 172, and the eighth contact portion 182 are uncovered by the insulation base 3. The five grounding solder pins 21 of the grounding terminal set 2 are also uncovered by the insulation base 3.

The insulation base 3 includes a base portion 31 and a plate portion 32. The plate portion 32 extends from the base portion 31 extends towards the first contact portion 112, the second contact portion 122, the third contact portion 132, the fourth contact portion 142, the fifth contact portion 152, the sixth contact portion 162, the seventh contact portion 172, and the eighth contact portion 182. The base portion 31 has two positioning holes 311 at a left end and a right end thereof respectively. The plate portion 32 includes a plurality of openings 321 formed on a top portion and a bottom portion thereof. The openings 321 correspond to the first signal section 113, the second signal section 123, the third signal section 133, the fourth signal section 143, the fifth signal section 153, the sixth signal section 163, the seventh signal section 173, and the eighth signal section 183, thereby exposing the first signal section 113, the second signal section 123, the third signal section 133, the fourth signal section 143, the fifth signal section 153, the sixth signal section 163, the seventh signal section 173, and the eighth signal section 183 to increase impedance of the signal terminal set 1.

Each of the light emitting members 7 includes two connecting terminals 17 configured to be inserted into the positioning holes 311 of the base 31, whereby the two light emitting members 7 are secured at the left end and the right end thereof respectively.

The light guiding member 4 includes two light guiding columns 41 disposed above the two light emitting members 7.

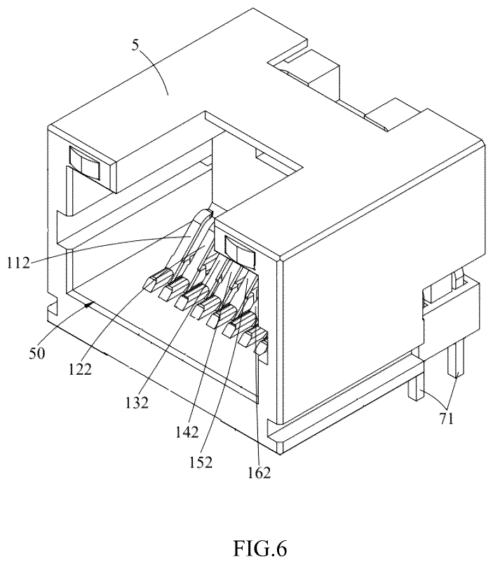

Referring to FIG. 6, the electrical connector structure 100 further includes an insulation housing 5 having an insertion space 50. The insulation housing 5 is configured to enclose the insulation base 3, the two light emitting members 7 and the two light guiding columns 41, whereby the plate portion 32 of the insulation base 3, the first contact portion 112, the second contact portion 122, the third contact portion 132, the fourth contact portion 142, the fifth contact portion 152, the sixth contact portion 162, the seventh contact portion 172, and the eighth contact portion 182 of the signal terminal set 1 are positioned in the insertion space 50. A front end of each light guiding column 41 is exposed from the insulation housing 5.

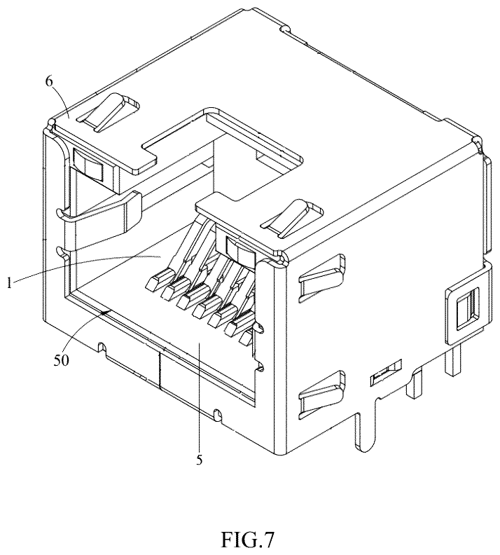

Referring to FIG. 7, the electrical connector structure 100 further includes a metal case 6 enclosing the insulation housing 5.

As aforementioned, two grounding solder pins 21 are disposed on a left side of the first signal solder pin 111 and on a right side of the eighth signal solder pin 181 to provide shielding against electromagnetic interference. The other three grounding solder pins 21 are disposed between every two signal solder pins to provide shielding against electromagnetic interference. In this way, one grounding solder pin 21 is disposed between the second signal solder pin 121 and the fourth signal solder pin 141, another grounding solder pin 21 is disposed between the third signal solder pin 131 and the fifth signal solder pin 151, and another grounding solder pin 21 is disposed between the sixth signal solder pin 161 and the seventh signal solder pin 171, whereby the first signal solder pin 111, the second signal solder pin 121, the third signal solder pin 131, the fourth signal solder pin 141, the fifth signal solder pin 151, the sixth signal solder pin 161, the seventh signal solder pin 171, the eighth signal solder pin 181, and the five grounding solder pins 21 are alternately arranged to reduce or even cease the electromagnetic interference between the first signal terminal 11, the second signal terminal 12, the third signal terminal 13, the fourth signal terminal 14, the fifth signal terminal 15, the sixth signal terminal 16, the seventh signal terminal 17 and the eighth signal terminal 18.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrical connector structure configured to mate with a plug of RJ45 connected to a cable, comprising:
a signal terminal set disposed in the electrical connector structure and comprising a first signal terminal provided with a first signal solder pin, a second signal terminal provided with a second signal solder pin, a third signal terminal provided with a third signal solder pin, a fourth signal terminal provided with a fourth signal solder pin, a fifth signal terminal provided with a fifth signal solder pin, a sixth signal terminal provided with a sixth signal solder pin, a seventh signal terminal provided with a seventh signal solder pin, and an eighth signal terminal provided with an eighth signal solder pin; and
a grounding terminal set disposed in the electrical connector structure and comprising at least five grounding solder pins;
wherein the first signal solder pin, the second signal solder pin, the third signal solder pin, the fourth signal solder pin, the fifth signal solder pin, the sixth signal solder pin, the seventh signal solder pin, the eighth signal solder pin, and the grounding solder pins are arranged along an identical direction in a sequence of one of the grounding solder pins, the first signal solder pin, the second signal solder pin, one of the grounding solder pins, the fourth signal solder pin, the fifth signal solder pin, one of the grounding solder pins, the third signal solder pin, the sixth signal solder pin, one of the grounding solder pins, the seventh signal solder pin, the eighth signal solder pin, and one of the grounding solder pins.

2. The electrical connector structure as claimed in claim 1, wherein the grounding terminal set further comprises a grounding substrate connected to the grounding solder pins and corresponding to a middle portion of the first signal terminal, the second signal terminal, the third signal terminal, the fourth signal terminal, the fifth signal terminal, the sixth signal terminal, the seventh signal terminal, and the eighth signal terminal respectively.

3. The electrical connector structure as claimed in claim 2, wherein the first signal terminal is provided with a first contact portion opposite to the first signal solder pin and a first signal section between the first contact portion and the first signal solder pin; the second signal terminal is provided with a second contact portion opposite to the second signal solder pin and a second signal section between the second contact portion and the second signal solder pin; the third signal terminal is provided with a third contact portion opposite to the third signal solder pin and a third signal section between the third contact portion and the third signal solder pin; the fourth signal terminal is provided with a fourth contact portion opposite to the fourth signal solder pin and a fourth signal section between the fourth contact portion and the fourth signal solder pin; the fifth signal terminal is provided with a fifth contact portion opposite to the fifth signal solder pin and a fifth signal section between the fifth contact portion and the fifth signal solder pin; the sixth signal terminal is provided with a sixth contact portion opposite to the sixth signal solder pin and a sixth signal section between the sixth contact portion and the sixth signal solder pin; the seventh signal terminal is provided with a seventh contact portion opposite to the seventh signal solder pin and a seventh signal section between the seventh contact portion and the seventh signal solder pin; the eighth signal terminal is provided with an eighth contact portion opposite to the eighth signal solder pin and an eighth signal section between the eighth contact portion and the eighth signal solder pin.

4. The electrical connector structure as claimed in claim 3, wherein the grounding substrate is located in a position corresponding to the first signal section, the second signal section, the third signal section, the fourth signal section, the fifth signal section, the sixth signal section, the seventh signal section, and the eighth signal section, whereby the first signal section, the second signal section, the fourth signal section, the fifth signal section, the seventh signal section, and the eighth signal section are positioned above the grounding substrate, and the third signal section and the sixth signal section are positioned under the grounding substrate.

5. An electrical connector structure configured to mate with a plug of RJ45 connected to a cable, comprising:
a signal terminal set disposed in the electrical connector structure and comprising a first signal terminal provided with a first signal solder pin, a second signal terminal provided with a second signal solder pin, a third signal terminal provided with a third signal solder pin, a fourth signal terminal provided with a fourth signal solder pin, a fifth signal terminal provided with a fifth signal solder pin, a sixth signal terminal provided with a sixth signal solder pin, a seventh signal terminal provided with a seventh signal solder pin, and an eighth signal terminal provided with an eighth signal solder pin; and
a grounding terminal set disposed in the electrical connector structure and comprising at least five grounding solder pins and a grounding substrate connected to the grounding solder pins and corresponding to a middle portion of the first signal terminal, the second signal terminal, the third signal terminal, the fourth signal terminal, the fifth signal terminal, the sixth signal terminal, the seventh signal terminal, and the eighth signal terminal respectively;
wherein the first signal solder pin, the second signal solder pin, the third signal solder pin, the fourth signal solder pin, the fifth signal solder pin, the sixth signal solder pin, the seventh signal solder pin, the eighth signal solder pin, and the grounding solder pins are arranged along an identical direction in a sequence of one of the grounding solder pins, the first signal solder pin, the second signal solder pin, one of the grounding solder pins, the fourth signal solder pin, the fifth signal solder pin, one of the grounding solder pins, the third signal solder pin, the sixth signal solder pin, one of the grounding solder pins, the seventh signal solder pin, the eighth signal solder pin, and one of the grounding solder pins.

6. An electrical connector structure configured to mate with a plug of RJ45 connected to a cable, comprising:
a signal terminal set disposed in the electrical connector structure and comprising a first signal terminal, a second signal terminal, a third signal terminal, a fourth signal terminal, a fifth signal terminal, a sixth signal terminal, a seventh signal terminal and an eighth signal terminal, wherein the first signal terminal is provided with a first signal solder pin, a first contact portion opposite to the first signal solder pin and a first signal section between the first contact portion and the first signal solder pin, the second signal terminal is provided with a second signal solder pin, a second contact portion opposite to the second signal solder pin and a second signal section between the second contact portion and the second signal solder pin, the third signal terminal is provided with a third signal solder pin, a third contact portion opposite to the third signal solder pin and a third signal section between the third contact portion and the third signal solder pin, the fourth signal terminal is provided with a fourth signal solder pin, a fourth contact portion opposite to the fourth signal solder pin and a fourth signal section between the fourth contact portion and the fourth signal solder pin, the fifth signal terminal is provided with a fifth signal solder pin, a fifth contact portion opposite to the fifth signal solder pin and a fifth signal section between the fifth contact portion and the fifth signal solder pin, the sixth signal terminal is provided with a sixth signal solder pin, a sixth contact portion opposite to the sixth signal solder pin and a sixth signal section between the sixth contact portion and the sixth signal solder pin, the seventh signal terminal is provided with a seventh signal solder pin, a seventh contact portion opposite to the seventh signal solder pin and a seventh signal section between the seventh contact portion and the seventh signal solder pin, and the eighth signal terminal is provided with an eighth signal solder pin, an eighth contact portion opposite to the eighth signal solder pin and an eighth signal section between the eighth contact portion and the eighth signal solder pin;
a grounding terminal set disposed in the electrical connector structure and comprising at least five grounding solder pins and a grounding substrate connected to the grounding solder pins and corresponding to a middle portion of the first signal terminal, the second signal terminal, the third signal terminal, the fourth signal terminal, the fifth signal terminal, the sixth signal terminal, the seventh signal terminal, and the eighth signal terminal respectively ;
wherein the first signal solder pin, the second signal solder pin, the third signal solder pin, the fourth signal solder pin, the fifth signal solder pin, the sixth signal solder pin, the seventh signal solder pin, the eighth signal solder pin, and the grounding solder pins are arranged along an identical direction in a sequence of one of the grounding solder pins, the first signal solder pin, the second signal solder pin, one of the grounding solder pins, the fourth signal solder pin, the fifth signal solder pin, one of the grounding solder pins, the third signal solder pin, the sixth signal solder pin, one of the grounding solder pins, the seventh signal solder pin, the eighth signal solder pin, and one of the grounding solder pins.

7. The electrical connector structure as claimed in claim 6, wherein the first signal section, the second signal section, the fourth signal section, the fifth signal section, the seventh signal section, and the eighth signal section are positioned above the grounding substrate, and the third signal section and the sixth signal section are positioned under the grounding substrate.

8. The electrical connector structure as claimed in claim 6, further comprising an insulation base enclosing the signal terminal set and the grounding terminal set, wherein the first signal solder pin, the second signal solder pin, the third signal solder pin, the fourth signal solder pin, the fifth signal solder pin, the sixth signal solder pin, the seventh signal solder pin, the eighth signal solder pin, the first contact portion, the second contact portion, the third contact portion, the fourth contact portion, the fifth contact portion, the sixth contact portion, the seventh contact portion, the eighth contact portion, and the grounding solder pins are uncovered by the insulation base, the insulation base comprises a base portion and a plate portion, a plurality of openings are formed on a top portion and a bottom portion of the plate portion, and the openings are configured to expose the first signal section, the second signal section, the third signal section, the fourth signal section, the fifth signal section, the sixth signal section, the seventh signal section, and the eighth signal section.

9. The electrical connector structure as claimed in claim 8, further comprising a light guiding member and at least two light emitting members secured at a right side and a left side of the base portion respectively, the light guiding member comprises two light guiding columns disposed at a top of the light emitting members respectively.

10. The electrical connector structure as claimed in claim 9, further comprising an insulation housing and a metal case, wherein the insulation housing is provided with an insertion space and encloses the insulation base, the light emitting members and the light guiding columns, whereby the plate portion, the first contact portion, the second contact portion, the third contact portion, the fourth contact portion, the fifth contact portion, the sixth contact portion, the seventh contact portion and the eighth contact portion are disposed in the insertion space, a front end of each of the light guiding columns is exposed from the insulation housing, and the metal case encloses the insulation housing.
